(19) United States
(12) Patent Application Publication
(10) Pub. No.: US 2007/0282614 A1
(43) Pub. Date: Dec. 6, 2007

(54) A METHOD FOR COLLABORATIVE CREATION OF ARTWORK BY A LARGE PLURALITY OF USERS USING A COMMUNICATIONS NETWORK

(76) Inventor: Christian Dreke, Portland, OR (US)

Correspondence Address: Christian Dreke, 8938 NW Ryan Street, Portland, OR, 97229, US

(21) Appl. No.: 11/420,795

(22) Filed: May 29, 2006

(51) Int. Cl. G06Q 10/00; G05B 19/418; G06F 9/46

(52) U.S. Cl. 705/1; 705/8

(57) ABSTRACT

A method for collaborative creation of artwork by a plurality of users is presented. According to an embodiment of the present invention, a plurality of users log onto the Internet and transmit to a collaboration server partial artwork and location information. Said collaboration server assembles said partial artwork and makes it available for viewing and voting by a plurality of users. A voting mechanism determines which partial artwork submissions are accepted and which are rejected. Said accepted partial artwork submissions are stored by said collaboration server. Said collaboration server continues to receive and store accepted partial artwork submissions for a configurable amount of time. Said collaboration server and voting mechanism mark said plurality of accepted partial artwork as final once enough votes have been received in favor of finalization. Said finalized plurality of accepted partial artwork arranged according to said location information constitutes the final artwork produced by the collaboration.

### BACKGROUND

1. Technical Field

The present invention relates to the field of computer network environments. More particularly, the present invention pertains to the collaborative creation of artwork by a large plurality of users using a communications network, a plurality of client computing devices, a server computing device, and a voting mechanism.

2. Background of the Invention

Current network technology, such as the Internet, permits storing, updating and retrieving of network resources containing audio and/or visual information, including but not limited to web pages, text files, picture files, sound files. As is known by those skilled in the art, said network resources can be addressed and made accessible via a standard uniform resource locator (URL) and web browser such as Microsoft Internet Explorer, Netscape Communicator and others.

Further, as is known by those skilled in the art, a number of standard protocols and mechanisms exist which allow transmission of said network resources over a communications network between client computing devices and server computing devices. As is known to those skilled in the art, said protocols and mechanisms include, but are not limited to, HTTP, SOAP, and WebDAV.

In addition, several electronic voting mechanisms exist in the public domain for determining an outcome by user vote. Said voting mechanisms include but are not limited to majority rule by which the majority of the votes cast towards a particular outcome determine the overall outcome of the vote.

The invention described herein is novel in nature allowing a large plurality of users to create artwork collaboratively aided by a communications network, a server computing device in the form of a collaboration server adapted to said communications network and coupled to a data store, a plurality of client computing devices adapted to said communications network and a voting mechanism used to determine inclusion or exclusion of partial artwork in the final artwork. The novel method described herein leverages a plurality of users to collaboratively create a single artwork during a collaboration from a large plurality of partial artwork.

### SUMMARY OF THE INVENTION

According to one embodiment of the present invention, a method for collaborative creation of artwork by a large plurality of users using a communications network, a plurality of client computing devices, a server computing device, and a voting mechanism is provided.

For illustrative purposes the artwork created by the present invention is envisioned to be a written story. However, the present invention is not limited to create a written story, rather it can be used to create any type of audio and/or visual artwork which can be transmitted and stored electronically, including but not limited to short stories, novels, pictures, paintings, audio stories, movie scripts, and animations.

In one embodiment of the present invention, a new artwork collaboration starts when a first user submits a first partial artwork in the form of a text file containing written text. Said partial artwork is transmitted electronically via a communications network from a client computing device to a server computing device using a standard network communication protocol, including but not limited to the hypertext transfer protocol, known to those skilled in the art as HTTP. Said server computing device stores said partial artwork using a data store coupled to said server computing device. Said server computing device also makes available for retrieval said partial artwork for the purpose of viewing by a large plurality of users. Said retrieval of said partial artwork is accomplished using a standard network protocol, including but not limited to the hypertext transfer protocol (HTTP).

In one embodiment of the present invention, a plurality of users vote to accept or reject said partial artwork during a configurable time period following the submission of said partial artwork. The voting mechanism uses a standard network protocol, including but not limited to HTTP, to transmit the votes from client computing devices to said server computing device. In one embodiment of the present invention, said voting mechanism uses majority rule to determine the outcome of the vote. Said majority rule voting mechanism determining acceptance or rejection of said partial artwork based on the majority count of said votes. If said voting mechanism has determined said partial artwork submission as accepted, the computing instructions executing on said server computing device mark said partial artwork as accepted, otherwise, said partial artwork is marked as rejected and discarded.

Additional submissions of partial artwork include location information for said partial artwork within the plurality of accepted partial artwork of said collaboration. Any additional submission of partial artwork when accepted as determined by said voting mechanism becomes part of the plurality of accepted artwork at said location and is stored by the computing instructions executing on said server computing device. Any successive submission of partial artwork when rejected as determined by said voting mechanism is marked as rejected and discarded by the computing instructions executing on said server computing device.

According to one embodiment of the present invention, a user can request a vote on the finalization of the plurality of accepted partial artwork of the collaboration after a configurable amount of time. Said finalization request is accepted or rejected based on a voting mechanism such as, but not limited to, majority rule in which the voting outcome is determined by a majority count. If said voting mechanism determines said finalization request is to be accepted, said plurality of accepted partial artwork is marked as final and no further partial artwork submission is processed for inclusion in said plurality of accepted partial artwork. Said plurality of accepted partial artwork arranged according to said location information constitutes the finalized artwork for said artwork collaboration.

### BRIEF DESCRIPTION OF THE DRAWINGS

FIG. 1 is an illustration of an exemplary network environment in which the present invention may be utilized.

FIG. 2 is an illustration of an exemplary computing system environment in which the invention may be implemented.

FIG. 3 is an exemplary block diagram illustrating basic components of the system according to one embodiment of the invention.

FIG. 4 is an exemplary flow chart illustrating the method of the present invention for collaborative creation of artwork by a large plurality of users using a communications network.

### DETAILED DESCRIPTION OF THE INVENTION

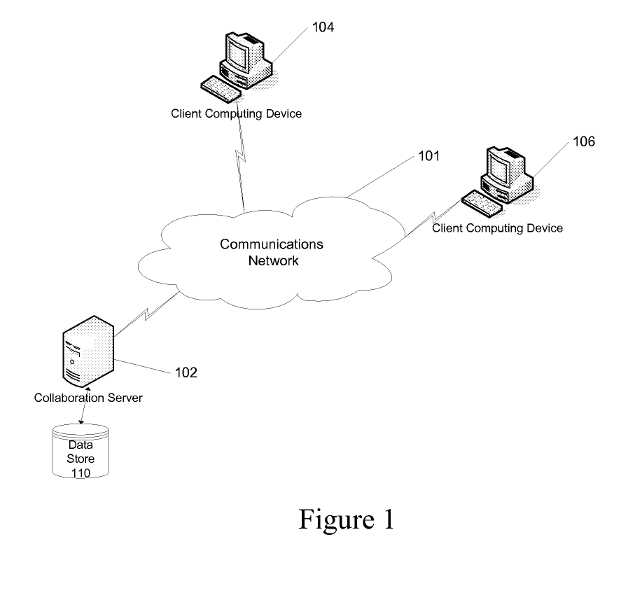

Referring now to the drawings, FIG. 1 illustrates an exemplary network environment in which the present invention may be utilized to assemble partial artwork into a whole via a server computing device in the form of collaboration server 102 coupled to a data store 110, a communications network 101, and client computing devices 104 and 106. FIG. 1 diagrammatically shows a network collaboration environment between client computing devices 104 and 106 and a collaboration server 102 via communications network 101. While FIG. 1 only shows two client computing devices 104 and 106, the present invention is meant to support a large plurality of client computing devices and users (not shown) for collaborating to create an artwork.

FIG. 1 illustrates said collaboration server 102 receiving partial artwork with a proposed location for assembly into the plurality of accepted partial artwork of a collaboration. Said collaboration server 102 uses data store 110 to store the plurality of partial artwork submissions and associated location information and to retrieve said partial artwork and location information when requested by a plurality of users (not shown) using client computing devices such as 104 and 106 for the purpose of viewing said partial artwork. For each partial artwork submitted by a user (not shown) via client computing device such as 104 or 106 and communications network 101, said collaboration server 102 receives and stores a plurality of votes which are used by a voting mechanism (not shown) to determine if said partial artwork is accepted or rejected. If said partial artwork was accepted for assembly into the plurality of previously accepted partial artwork at said location, collaboration server 102 stores said accepted partial artwork alongside said previously accepted partial artwork at said location via data store 110.

Client computing devices 104 and 106 are adapted to a communications network 101 in FIG. 1. In this example, said communications network 101 is the Internet (or the World Wide Web). However, the present invention can be applied to any data communications network including a local area network (LAN), a wide area network (WAN), or a value added network (VAN). For exemplary purposes two client computing devices 104 and 106 are shown to be adapted to communications network 101. However, a large plurality of client computing devices can exist and be adapted to the communications network 101 as is the case for the Internet. For exemplary purposes one collaboration server 102 is shown to be adapted to communications network 101. However, a plurality of collaboration servers can exist and be adapted to communications network 101. Each of the client computing devices 104 and 106 can access the collaboration server 102 via communications network 101.

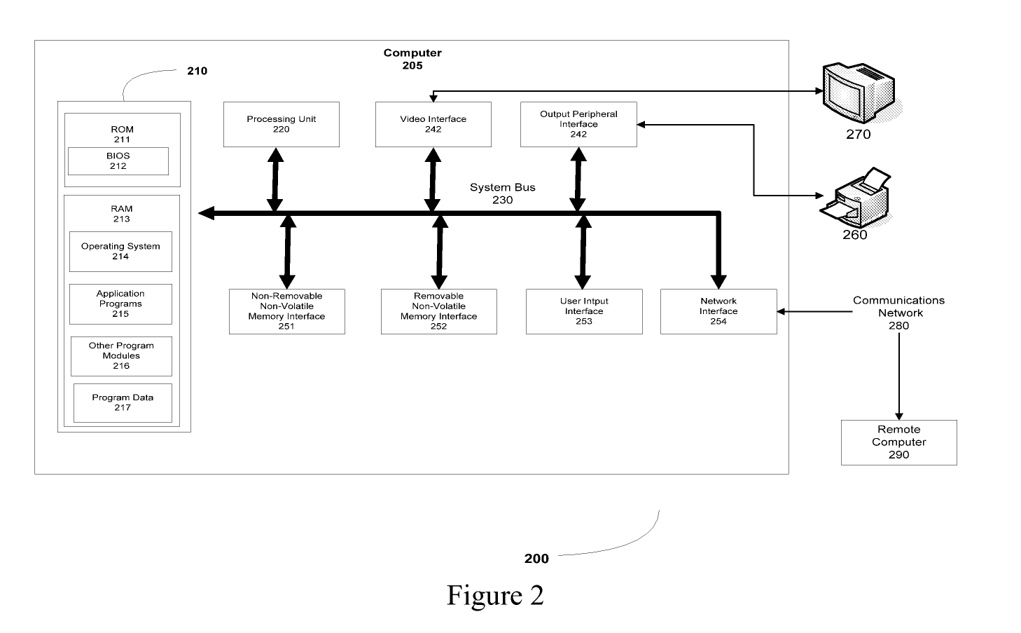

FIG. 2 illustrates an example of a suitable computing system environment 200 in which the present invention may be implemented. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary computing environment 200.

FIG. 2 shows one example of a general purpose computing device in the form of a computer 205. In one embodiment of the present invention, a computer such as the computer 205 is suitable for use in the other figures illustrated and described herein. Computer 205 has one or more processors or processing units 220 and a system memory 210. In the illustrated embodiment, a system bus 230 couples various system components including the system memory 210 to the processors 220. The bus 230 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 205 typically has at least some form of computer readable media. Computer readable media, which include both volatile and nonvolatile media, removable and non-removable media, may be any available medium that can be accessed by computer 205. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computer 205.

The system memory 210 includes computer storage media in the form of removable and/or non-removable, volatile and/or nonvolatile memory. In the illustrated embodiment, system memory 210 includes read only memory (ROM) 211 and random access memory (RAM) 213. A basic input/output system 212 (BIOS), containing the basic routines that help to transfer information between elements within computer 205, such as during start-up, is typically stored in ROM 211. RAM 213 typically contains data and/or program modules that are immediately accessible to and/or presently being operated on by processing unit 230.

The computer 205 typically also include removable/non-removable, volatile/nonvolatile computer storage media which are coupled to system bus 230 via removable non-volatile memory interface 252 and removable non-volatile memory interface 251. Mass storage drives (not shown) or other mass storage devices (not shown) and their associated computer storage media (not shown) are examples of such computer storage media. They provide storage of computer readable instructions, data structures, program modules and other data for the computer 205

A user may enter commands and information into computer 205 through input devices or user interface selection devices (not shown) such as a keyboard and a pointing device (e.g., a mouse, trackball, pen, or touch pad). Other input devices (not shown) may include a microphone, joystick, game pad, satellite dish, scanner, or the like. These and other input devices are connected to processing unit 220 through a user input interface 253 that is coupled to system bus 230, but may be connected by other interface and bus structures, such as a parallel port, game port, or a Universal Serial Bus (USB). A monitor 270 or other type of display device is also connected to system bus 230 via an interface, such as a video interface 242. In addition to the monitor 230, computers often include other peripheral output devices such as a printer 260 and speakers (not shown), which may be connected through an output peripheral interface 243.

The computer 205 may operate in a networked environment using a communications network 280 to one or more remote computers, such as a remote computer 290. The remote computer 290 may be a personal computer, a server, a router, a network PC, a peer device or other common network node, and typically includes many or all of the elements described above relative to computer 205. Examples for the communications network 280 include, but are not limited to a local area network (LAN), a wide area network (WAN), and the Internet. The computer 205 is coupled to the communications network 280 via the network interface 254.

Although described in connection with an exemplary computing system environment 200, including computer 205, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

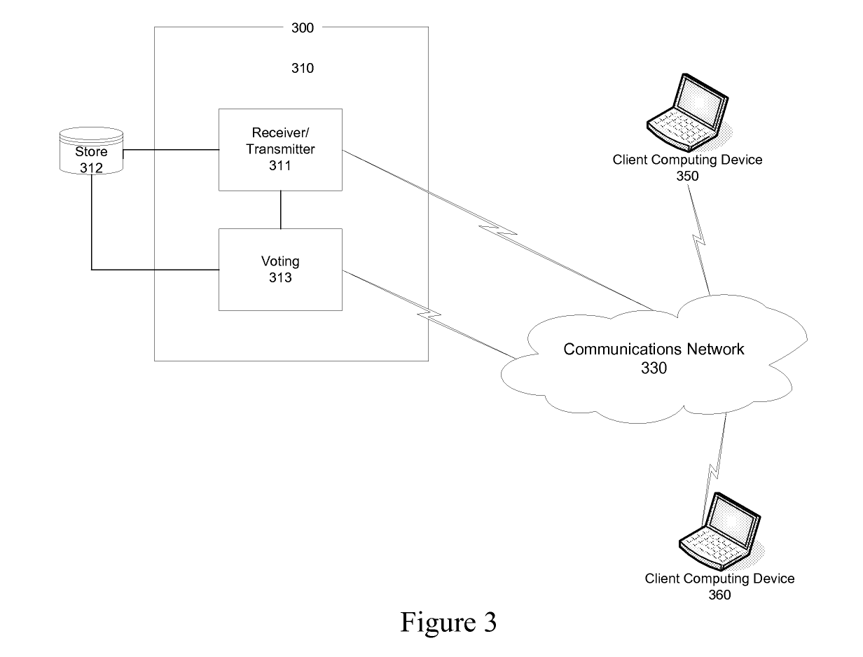

Referring next to FIG. 3, an exemplary block diagram illustrating one embodiment of the components of the present invention. The collaboration server 300 comprises the receiver/transmitter component 311 coupled to a data store 312 and a voting component 313. The receiver/transmitter component 311 is adapted to communications network 330 for the purposes of communicating with client computing device 350 and 360. The voting component 313 is coupled to receiver/transmitter component 311 and data store 312 for the purposes of processing votes and accepting or rejecting partial artwork, as well as finalizing a plurality of accepted partial artwork.

According to the present invention, the collaboration server 300 executes a computer program including receiver/transmitter component 311 and voting component 313. The receiver/transmitter component 311 having instructions for receiving, transmitting, and storing data containing artwork in electronic form, associated location information for said artwork and voting information. The voting component 313 having instructions for processing and storing votes pertaining to said artwork.

A new collaboration for artwork starts when said receiver/transmitter component 311 receives a first submission of partial artwork and associated location information for said partial artwork via communications network 330 from a client computing device such as client computing device 350 or 360. Next, receiver/transmitter component 311 stores said partial artwork and said associated location information using data store 312. Next, receiver/transmitter component 311 receives a plurality of retrieval requests for said partial artwork submission via communications network 330 from a plurality of client computing devices such as client computing devices 350 and 360. Receiver/transmitter component 311 returns to said client computing devices any previously accepted partial artwork of said collaboration as well as said partial artwork submission at said location.

Next, the receiver/transmitter component 311 receives a plurality of votes for said partial artwork submission via communications network 330 from a plurality of users (not shown) using client computing devices such as 350 and 360. In one embodiment of the present invention, voting component 313 waits for a configurable amount of time before accepting or rejecting said partial artwork submission based on a majority of said votes.

If voting component 313 accepts said partial artwork submission, it stores said partial artwork submission as part of the plurality of accepted partial artwork using data store 312. If voting component 313 rejects said partial artwork submission, it marks said artwork submission as rejected and stores this fact using data store 312.

In one embodiment of the present invention, the receiver/transmitter component 311 receives a request for finalization of the plurality of accepted partial artwork. Next, the receiver/transmitter component 311 receives votes for said finalization request. Next, voting component 313 determines if said finalization request is accepted or rejected. If said finalization request is accepted, said plurality of accepted partial artwork is marked as final by voting component 313 using data store 312. Once said plurality of accepted partial artwork has been marked as final, all subsequent partial artwork submissions will be rejected for said collaboration.

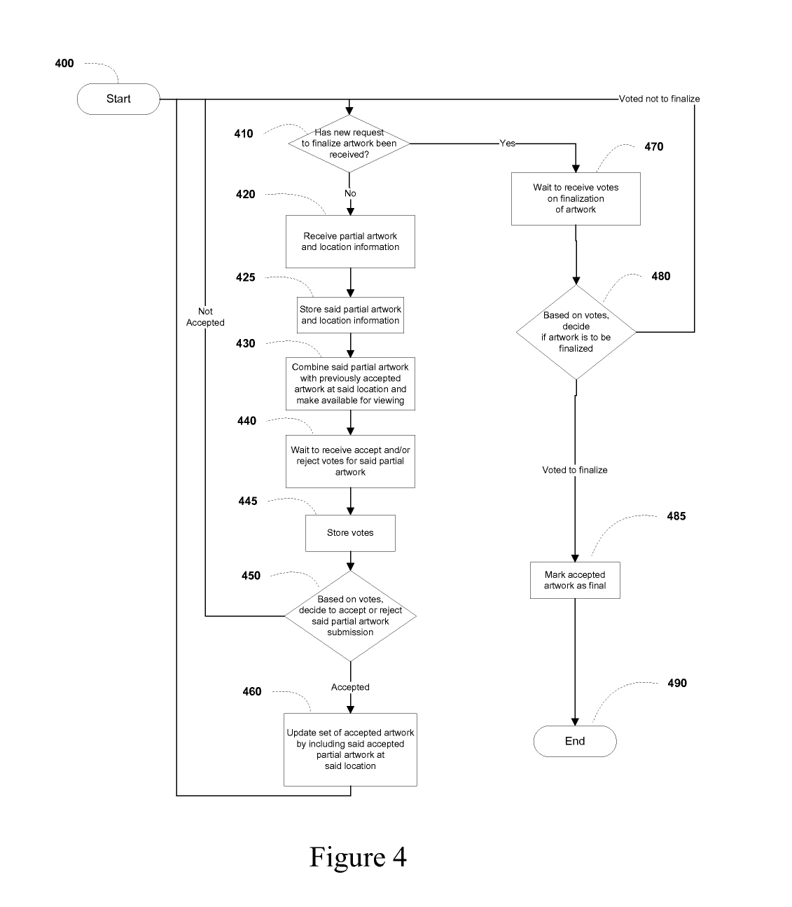

Referring now to FIG. 4, an exemplary flow chart illustrating the process flow for collaborative creation of artwork by a large plurality of users using a communications network. The process start 400 occurs when the programming code instructions for the receiver/transmitter component start executing within the collaboration server. First, the receiver/transmitter component determines if a new request to finalize previously accepted artwork has been received 410. In one embodiment of the present invention, if said finalization request has not been received, the receiver/transmitter component waits for a configurable period of time to receive a new submission of partial artwork and location information 420.

Once a new submission of partial artwork and location information has been received, the receiver/transmitter component stores said partial artwork and location information 425. Next, the receiver/transmitter component makes available for retrieval and viewing the plurality of previously accepted partial artwork and said newly submitted partial artwork, whereas said newly submitted partial artwork is temporarily included into said plurality of previously accepted partial artwork at said location 430.

In one embodiment of the present invention, the receiver/transmitter component then waits a configurable amount of time to receive votes for said newly submitted partial artwork 440. Votes received during said time period are stored by said receiver/transmitter component using a data store 445.

In one embodiment of the present invention, after said time period has elapsed, the voting component determines based on the majority count of accept and reject votes if said partial artwork is to be accepted or rejected at said location 450. If said partial artwork is accepted, the voting component updates said plurality of accepted partial artwork to include said newly submitted partial artwork at said location 460. If said newly submitted partial artwork is rejected, the voting component discards said newly submitted partial artwork and returns control to the receiver/transmitter component 410.

In one embodiment of the present invention, if said new request to finalize the plurality of accepted partial artwork has been received by said receiver/transmitter component, said receiver/transmitter component waits a configurable time period in which to receive votes to accept or reject finalization of said accepted partial artwork 470. After said time period has elapsed, said voting component determines based on the majority of the received votes if said plurality of accepted partial artwork should be finalized or not 480. If said majority vote count is to accept the finalization request, said voting component marks said plurality of accepted partial artwork as final and no further submissions of any new partial artwork are accepted into said plurality of accepted partial artwork 485. Said plurality of accepted partial artwork constitutes the final artwork for said collaboration 490.

As various changes could be made in the above constructions and methods without departing from the scope of the invention, it is intended that all matter contained in the above description and shown in the accompanying drawings shall be interpreted as illustrative and not in a limiting sense.

What is claimed:

1. A method for collaborative creation of artwork by a plurality of users, comprising:
starting an artwork collaboration when receiving a first message from a user, said message containing partial artwork and location information in electronic form;
receiving a plurality of messages from a plurality of users for said artwork collaboration, each message in said plurality of messages including partial artwork in electronic form and location information for said partial artwork;
receiving a plurality of votes for each message contained in said plurality of messages;
determining acceptance or rejection for each message contained in said plurality of messages based on said plurality of votes and a voting mechanism;
receiving a finalization message from a user, said finalization message containing a request to finalize said artwork collaboration;
receiving a plurality of votes for said finalization message;
determining acceptance or rejection of said finalization of said artwork collaboration based on said plurality of votes for said finalization message and a voting mechanism;

2. The method of claim 1, further comprising:
each message in said plurality of messages optionally containing changes to the plurality of accepted partial artwork.

3. The method of claim 2, further comprising:
said location information for said partial artwork determining the spatial and/or temporal location of said partial artwork within said artwork collaboration.

4. The method of claim 3, further comprising:
transmitting said plurality of messages received to a user upon request indicating which partial artwork submission has been accepted, which has been rejected, and which has not been accepted or rejected.

5. The method of claim 4, wherein said voting mechanism can be configured from a plurality of voting mechanisms, said plurality of voting mechanisms comprising:
counting all votes received within a configurable amount of time;
counting a configurable number of votes received within a configurable amount of time;
counting only votes received within a configurable amount of time from users with one or more previous contributions of accepted partial artwork;
counting only votes received within a configurable amount of time from users with zero previous contributions of accepted partial artwork;

6. The method of claim 5, wherein said votes contain information indicating acceptance or rejection of said partial artwork and wherein acceptance of said partial artwork is determined when a majority of said counted votes indicates acceptance.

7. A system for collaborative creation of artwork by a plurality of, said system comprising:
a communications network;
a plurality of client computing devices adapted to be present on said communications network;
a server computing device adapted to be present on said communications network;
a receiving/transmission component executing within said server computing device, allowing reception and transmission of partial artwork, associated location information for said partial artwork and voting information from a plurality of users via said plurality of client computing devices;
a voting component executing within said server computing device responsive to said receiver/transmitter component for processing received voting information, determining voting outcome and accepting, rejecting, and/or finalizing electronic artwork in response to said voting outcome;
a data store coupled to said receiver/transmitter and said voting component for storing electronic artwork and voting information.

8. The system of claim 7, wherein the parts of the system are linked to each other via a communications network which is a local area network (LAN), a wide area network (WAN), or the Internet.

9. The system of claim 8, wherein a new collaboration starts when the receiver/transmitter component receives a first message containing partial artwork and location information.

10. The system of claim 9, wherein the receiver/transmitter component receives a plurality of additional partial artwork and location information for said partial artwork.

11. The system of claim 10, wherein the receiver/transmitter component receives voting information for each partial artwork in said plurality of partial artwork from a plurality of users using said client computing devices.

12. The system of claim 10, wherein the receiver/transmitter component receives voting information for each partial artwork in the plurality of partial artwork only from a plurality of users using said client computing devices who have previously submitted accepted partial artwork for said collaboration.

13. The system of claim 11 or 12, wherein said voting component determines if said received partial artwork is to be accepted or rejected based on voting information received by said receiver/transmission component and said accepted partial artwork is combined with the plurality of previously accepted partial artwork at said location.

14. The system of claim 13, wherein said partial artwork includes changes to the plurality of previously accepted partial artwork.

15. The system of claim 13 or 14, wherein said voting component can be configured to determine acceptance of said partial artwork based on a plurality of voting mechanisms, said plurality of voting mechanisms comprising:
counting all votes received within a configurable amount of time;
counting a configurable number of votes received within a configurable amount of time;
counting only votes received within a configurable amount of time from users with one or more previous contributions of accepted partial artwork;
counting only votes received within a configurable amount of time from users with zero previous contributions of accepted partial artwork;

16. The system of claim 15, wherein acceptance of said partial artwork is determined when a majority of said counted votes indicates acceptance.

17. The system of claim 16, wherein said accepted partial artwork is combined with the plurality of previously accepted partial artwork at said location.

18. The system of claim 17, wherein said receiver/transmitter component receives a request to finalize the plurality of said accepted partial artwork and voting information for said finalization request from a plurality of users.

19. The system of claim 18, wherein said voting component marks as final said plurality of accepted partial artwork if a majority of said received voting information indicates acceptance to finalize said plurality of accepted partial artwork

20. The system of claim 19, wherein said finalized plurality of accepted partial artwork constitutes the final artwork produced by said collaboration.
